(19) United States
(12) Patent Application Publication
(10) Pub. No.: US 2016/0110090 A1
(43) Pub. Date: Apr. 21, 2016

(54) Gesture-Based Content-Object Zooming

(71) Applicant: Microsoft Technology Licensing, LLC, Redmond, WA (US)

(72) Inventors: Michael J. Patten, Sammamish, WA (US); Paul Armistead Hoover, Bothell, WA (US); Jan-Kristian Markiewicz, Redmond, WA (US)

(21) Appl. No.: 14/977,462

(22) Filed: Dec. 21, 2015

Related U.S. Application Data
(62) Division of application No. 13/118,265, filed on May 27, 2011.

(51) Int. Cl. G06F 3/0484; G06T 13/80; G06F 3/0485; G06F 3/041

(52) U.S. Cl. CPC G06F 3/04847; G06F 3/041; G06T 13/80; G06F 3/0485; G06F 2203/04104

(57) ABSTRACT

This document describes techniques and apparatuses for gesture-based content-object zooming. In some embodiments, the techniques receive a gesture made to a user interface displaying multiple content objects, determine which content object to zoom, determine an appropriate size for the content object based on bounds of the object and the size of the user interface, and zoom the object to the appropriate size.

### RELATED APPLICATION

This application is a divisional of and claims priority under 35 U.S.C. §119(e) to U.S. patent application Ser. No. 13/118,265 titled “Gesture-Based Content-Object Zooming”, filed May 27, 2011, the disclosure of which is incorporated by reference herein in its entirety.

### BACKGROUND

Conventional gesture-based zooming techniques can receive a gesture and, in response, zoom into or out of a webpage. These conventional techniques, however, often zoom too much or too little. Consider a case where a mobile-device user inputs a gesture to zoom into a web page having advertisements and a news article. Conventional techniques can measure the magnitude of the gesture and, based on this magnitude, zoom the advertisements and the news article. In some cases this zooming zooms too much—often to a maximum resolution permitted by the user interface of the mobile device. In such a case a user may see half of the width of a page. In some other cases this zooming zooms too little, showing higher-resolution views of both the news article and the advertisements but not presenting the news article at a high enough resolution. In these and other cases, conventional zooming techniques often result in a poor user experience.

### SUMMARY

This document describes techniques and apparatuses for gesture-based content-object zooming. In some embodiments, the techniques receive a gesture made to a user interface displaying multiple content objects, determine which content object to zoom, determine an appropriate size for the content object based on bounds of the object and the size of the user interface, and zoom the object to the appropriate size.

This summary is provided to introduce simplified concepts for a gesture-based content-object zooming that are further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and apparatuses for gesture-based content-object zooming are described with reference to the following drawings. The same numbers are used throughout the drawings to reference like features and components:

FIG. 1 illustrates an example environment in which techniques for gesture-based content-object zooming can be implemented.

FIG. 2 illustrates an example method for gesture-based content-object zooming.

FIG. 3 illustrates an example tablet computing device having a gesture-sensitive display displaying content of a webpage in a user interface.

FIG. 4 illustrates the user interface of FIG. 3, a center point of a gesture, and content objects.

FIG. 5 illustrates a news article object of FIGS. 3 and 4 with horizontal and vertical bounds.

FIG. 6 illustrates a zoomed content object.

FIG. 7 illustrates the zoomed content object of FIG. 6 after a pan within the zoomed content object and within the horizontal bounds.

FIG. 8 illustrates an example device in which techniques enabling gesture-based content-object zooming can be implemented.

### DETAILED DESCRIPTION

### Overview

This document describes techniques and apparatuses for gesture-based content-object zooming. These techniques and apparatuses can permit users to quickly and easily zoom portions of content displayed in a user interface to an appropriate size. By so doing, the techniques enable users to view desired content at a convenient size, prevent over-zooming or under-zooming content, and/or generally aid users in manipulating and consuming content.

Consider a case where a user is viewing a web browser that shows a news article and advertisements, some of the advertisements on the top of the browser, some on each side, some on the bottom, and some intermixed within the body of the news article. This is not an uncommon practice among many web content providers.

Some conventional techniques can receive a gesture to zoom the webpage having the article and advertisements. In response, these conventional techniques may over-zoom, showing less than a full page width of the news article, which is inconvenient to the user. Or, in response, conventional techniques may under-zoom, showing the news article at too low a resolution and showing undesired advertisements on the top, bottom, or side of the article. Further still, even if the gesture happens to cause the conventional techniques to zoom the news article to roughly a good size, these conventional techniques often retain the advertisements that are intermixed within the news article, zooming them and the article.

In contrast, consider an example of the techniques and apparatuses for gesture-based content-object zooming. As noted above, the webpage has a news article and various advertisements. The techniques may receive a gesture from a user, determine which part of the webpage the user desires to zoom, and zoom that part to an appropriate size, often filling the user interface. Further, the techniques can forgo including advertisements and other content objects not desired by the user. Thus, with as little as one gesture made to this example webpage, the techniques can zoom the news article to the width of the pages, thereby providing a good user experience.

This is but one example of gesture-based content-object zooming—others are described below. This document now turns to an example environment in which the techniques can be embodied, various example methods for performing the techniques, and an example device capable of performing the techniques.

### Example Environment

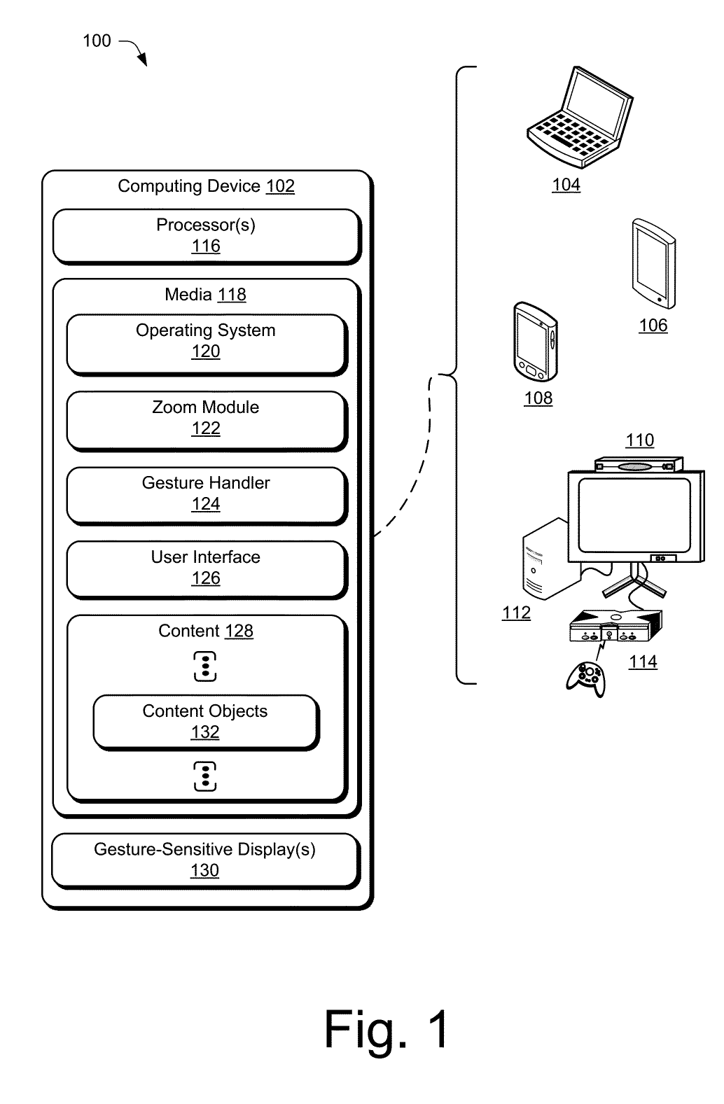

FIG. 1 illustrates an example environment 100 in which gesture-based content-object zooming can be embodied. Environment 100 includes a computing device 102, which is illustrated with six examples: a laptop computer 104, a tablet computer 106, a smart phone 108, a set-top box 110, a desktop computer 112, and a gaming device 114, though other computing devices and systems, such as servers and netbooks, may also be used.

Computing device 102 includes computer processor(s) 116 and computer-readable storage media 118 (media 118). Media 118 includes an operating system 120, zoom module 122 including or having access to gesture handler 124, user interface 126, and content 128. Computing device 102 also includes or has access to one or more gesture-sensitive displays 130, four examples of which are illustrated in FIG. 1.

Zoom module 122, alone, including, or in combination with gesture handler 124, is capable of determining which content object 132 to zoom based on a received gesture and causing user interface 126 to zoom this content object 132 to an appropriate size, as well as other capabilities.

User interface 126 displays, in one or more of gesture-sensitive display(s) 130, content 128 having multiple content objects 132. Examples of content 128 include webpages, such as social-networking webpages, news-service webpages, shopping webpages, blogs, media-playing websites, and many others. Content 128, however, may include non-webpages that include two or more content objects 132, such as user interfaces for local media applications displaying selectable images.

User interface 126 can be windows-based or immersive or a combination of these. User interface 126 may fill or not fill one or more of gesture-sensitive display(s) 130, and may or may not include a frame (e.g., a windows frame surrounding content 128). Gesture-sensitive display(s) 130 are capable of receiving a gesture having momentum, such as various touch and motion-sensitive systems. Gesture-sensitive display(s) 130 are shown as integrated systems having a display and sensors, though a disparate display and sensors can instead be used.

Various components of environment 100 can be integral or separate as noted in part above. Thus, operating system 120, zoom module 122, gesture handler 124, and/or user interface 126, can be separate from each other or combined or integrated in some form.

### Example Methods

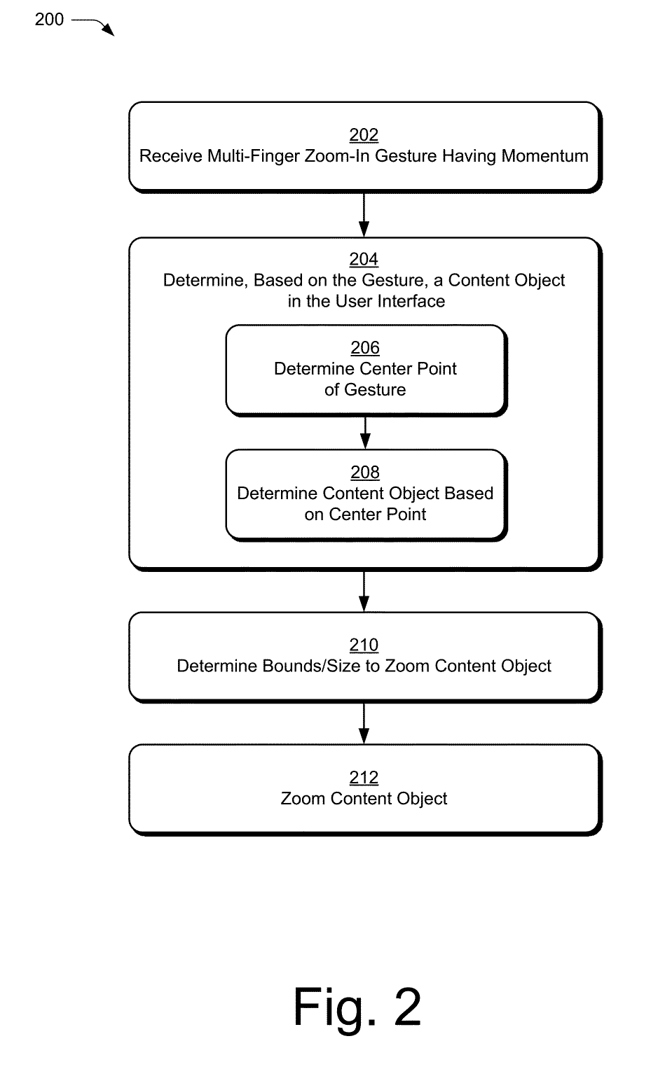

FIG. 2 depicts one or more method(s) 200 for gesture-based content-object zooming. These methods are shown as a set of blocks that specify operations performed but are not necessarily limited to the order shown for performing the operations by the respective blocks. In portions of the following discussion reference may be made to environment 100 of FIG. 1, reference to which is made for example only.

Block 202 receives a multi-finger zoom-in gesture having momentum. This gesture can be made over a user interface displayed on a gesture-sensitive display and received through that display or otherwise.

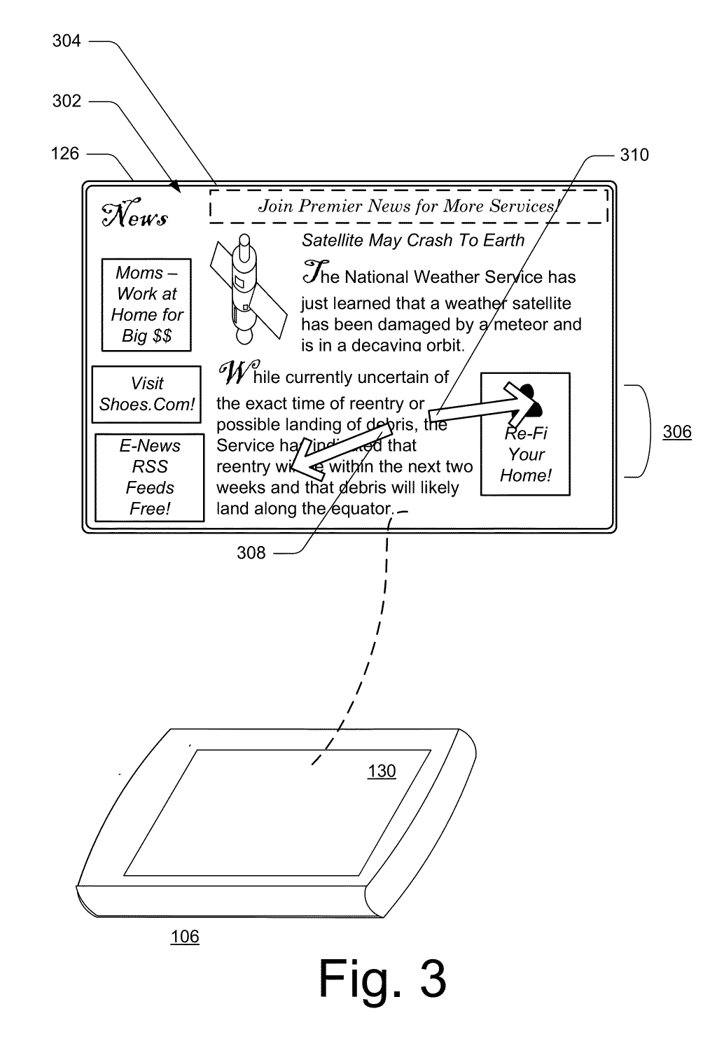

By way example consider FIG. 3, which illustrates a tablet computing device 106 having a gesture-sensitive display 130 displaying content 302 of a webpage 304 in user interface 126. A two-fingered spread gesture 306 is shown received over user interface 126 and received through gesture-sensitive display 130. Arrows 308, 310 indicate starting points, movement of the fingers from inside to outside, and end points at the arrow tips. For this example, assume that gesture handler 124 receives this gesture.

Note that momentum of a gesture is an indication that the gesture is intended to manipulate content quickly, without a fine resolution, and/or past the actual movement of the fingers. While momentum is mentioned here, inertia, speed, or other another factor of the gesture can indicate this intention and be used by the techniques.

Block 204 determines, based on the multi-finger zoom-in gesture, a content object of multiple content objects in the user interface. Block 204 may act in multiple manners to determine the content object to zoom based on the gesture. Block 204, for example, may determine the content object to zoom based on an amount of finger travel received over various content objects (represented by arrows 308 and 310 in FIG. 3), start points of the fingers in the gesture (represented by non-point parts of arrows 308 and 310), end points of the fingers in the gesture, or a center-point calculated from the gesture. In the ongoing example embodiment, zoom module 122 determines the content object based on the center-point of the gesture.

Block 204 is illustrated including two optional blocks 206 and 208 indicating one example embodiment in which the techniques may operate to determine the content object. Block 206 determines a center point of the gesture. Block 208 determines the content object based on this determined center point.

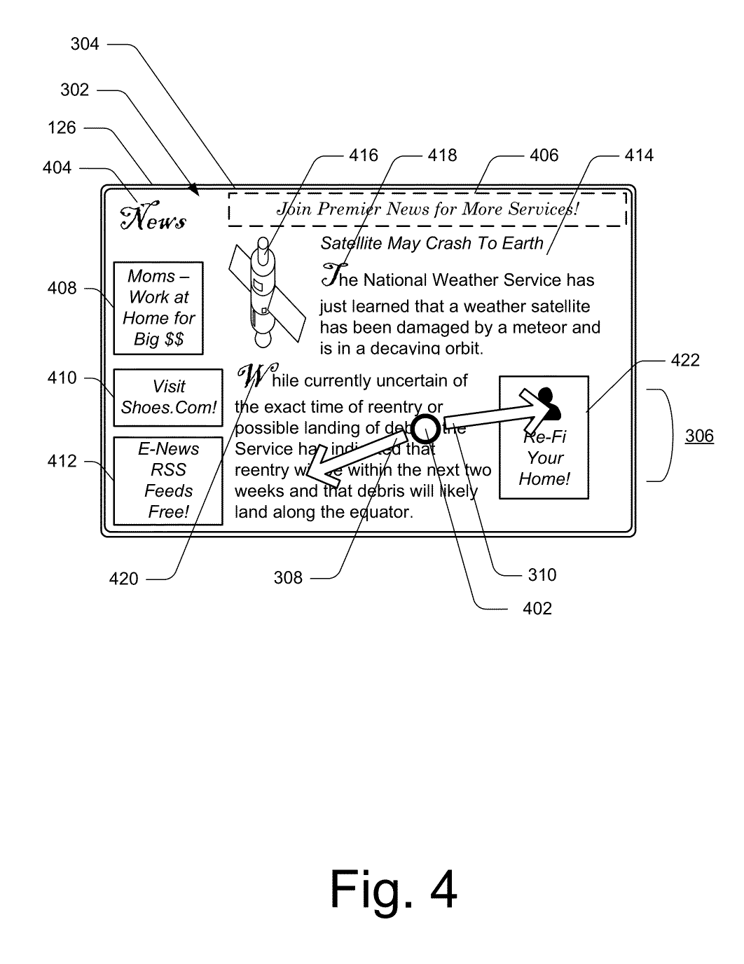

Continuing the ongoing embodiment, consider FIG. 4, which illustrates content 302 of webpage 304 from FIG. 3. In this embodiment, zoom module 122 receives information about the gesture from gesture handler 124. With this information, at block 206 zoom module 122 determines a center point of gesture 306. This center point is shown at 402 in FIG. 4.

Following determination of this center point 402, at block 208 zoom module 122 determines the content object to zoom. In this case zoom module 122 does so by selecting the content object in which center point 402 resides. By way of illustration, consider numerous content objects of content 302, including: webpage name object 404; top advertisement object 406; first left-side advertisement object 408; second left-side advertisement object 410; third left-side advertisement object 412; news article object 414; article image object 416; first article icon object 418; second article icon object 420; and internal advertisement object 422.

In some situations, however, a content object in which the center point or other factor indicates may not be a best content object to zoom. By way of example, assume that zoom module 122 determines a preliminary content object in which the center point resides and then determines, based on a size of the preliminary content object and a size of the user interface, whether the preliminary content object can substantially fill the user interface at a maximum resolution of the user interface. Thus, in the example of FIG. 4, assume that the center point does not reside within news article object 414, but instead resides within first article icon object 418. Here zoom module 122 determines that object 418, at a maximum zoom of 400 percent, cannot substantially fill the user interface. In response, zoom module 122 can select a different object, here news article object 414 either because object 418 is subordinate to object 414 or graphically includes object 418.

In some cases determining a content object is performed based on a logical division tag (e.g., a “<div>” tag in XHTML) of the preliminary content object and within a document object model (DOM) having the logical division tag subordinate to a parent logical division tag associated with the parent content object. This can be performed in cases where rendering of content 302 by user interface 126 includes use of a DOM having tags identifying the content objects, though other manners may also be used. In the immediate example of objects 418 and 414, the DOM indicates that a logical division tag for first article icon object 418 is hierarchically subordinate to a logical division tag for news article object 414.

Similarly, the techniques may find a preliminary content object to be too large. Zoom module 122, for example, can determine, based on a current size of the preliminary content object and the size of the user interface, that the preliminary content object currently fills the user interface. In such a case, zoom module 122 finds and then sets a child content object of the preliminary content object as the content object. While not shown, assume that a content object fills user interface 126 and has many subordinate content objects, such as a large content object having many images, each image being a subordinate object. Zoom module 122 can determine that a received gesture has a center point in the large object but not the smaller image objects, or that the an amount of finger travel received over various content objects is received mostly by the larger object and less by one of the image objects. The techniques permit correction of this likely inappropriate determination of a content object.

Similarly to as noted above for DOMs, in some cases this child content object is found based on a logical division tag of the preliminary (large) content object within a document object model being superior to a logical division tag associated with the child content object. Zoom module 122 may also or instead determine the child content object based on analyzing the small content objects similarly to block 204, but repeated. In such a case, the small content object may be determined by being closest to the center point, having more of the finger travel than other small content objects, and so forth.

Block 210 determines one or more bounds of, and/or a size to zoom, the content object. Zoom module 122 determines an appropriate zoom for the content object based on a size of user interface 126 and bounds of the determined content object. Zoom module 122 may determine the bounds dynamically, and thus in real time, though this is not required.

Returning to the example of FIG. 4, assume that zoom module 122 determines that the news article object 414 is the appropriate content object to zoom. To determine the amount to zoom the content object, zoom module 122 determines an amount of available space in the user interface, which is often substantially all or all of the user interface, though this is not required. Here assume that all of webpage 304 is found to be the maximum size.

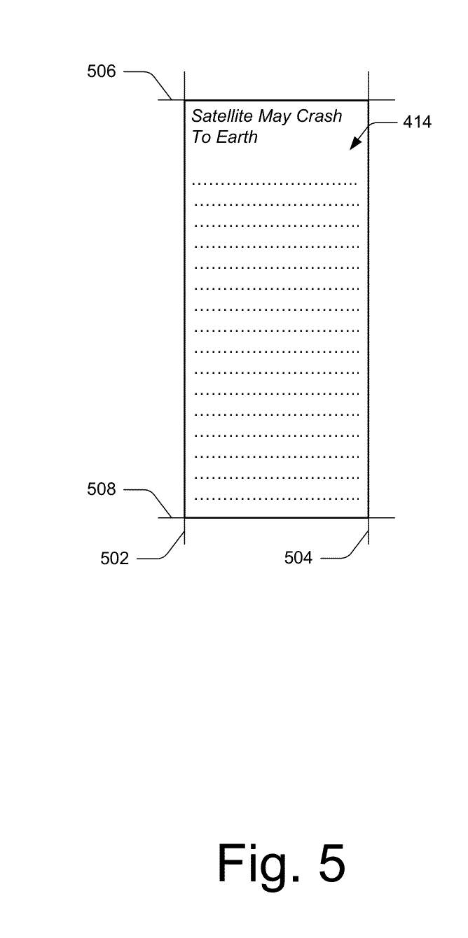

Zoom module 122 also determines bounds of news article object 414. News article object 414 has bounds indicating a page width and total length. This is illustrated in FIG. 5, which shows news article object 414 with horizontal bounds 502, 504 indicating the page width and vertical bounds 506, 508.

Often all of the bounds do not fit perfectly in available space without distortion of the object, similar to a television program having a 4:3 ratio not fitting into a display having a 16:9 ratio (not without distortion or unoccupied space). Here the news article has bounds for a page width that fits well into webpage 304. Some of the article is not shown, but can be selected later.

Block 212 zooms or causes the user interface to zoom the determined content object. Block 212 can pass information to another entity indicating an appropriate amount to zoom the object, how to orient it, a center point for the zoom, and various other information. Block 212 may instead perform the zoom directly.

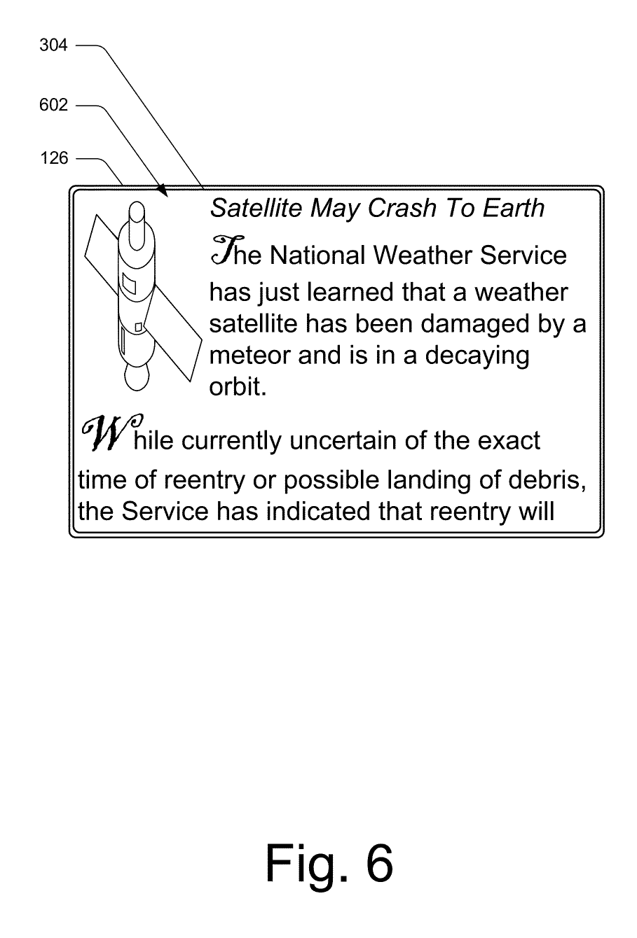

Continuing the example, zoom module 122 zooms the news article about 50% to fit the webpage 304 at the object's horizontal bounds (here page width). This is illustrated in FIG. 6 at zoomed content object 602. This 200% zoom is effective to substantially fill user interface 126.

Note that zoom module 122 zooms objects that are subordinate to news article object 414 but ceases to present other objects. Thus, article image object 416, first article icon object 418, and second article icon object 420 are all zoomed about 200%. Advertisement objects, even those geographically included within the news article as shown in FIGS. 3 and 4 at 422 are not included.

Ways in which the content object is zoomed can vary. In some cases the content object is zoomed to a new, larger size without showing any animation or a progressive change in the resolution. In effect, user interface replaces current content with the zoomed content object. In other cases zoom module 122 or another entity, such operating system 120, displays a progressive zooming animation from an original size of the content object to a final size of the content object. Further, other animations may be used, such as to show that the bounds are being “snapped to,” such as a shake or bounce at or after the final size is shown. If operating system 120, for example, uses a consistent animation for zooming, this animation may be used for a consistent user experience.

While the current example presents a content object zoomed to fit based on two bounds of the object (502 and 504 of FIG. 5), one, others, or all four bounds may be used. Thus, a content object may be zoomed to show all of the content object where appropriate, even if it may in some cases leave empty space. Images are often preferred to be zoomed in this manner.

Following a zoom of the content object at, or responsive to, block 212, other gestures may be received. These may include to zoom back to a prior view, e.g., that of FIG. 3. Or a gesture to further zoom the content object past the current zoom or bounds.

On receiving a zoom out, multi-finger gesture, for example, zoom module 122 may zoom out the content object within the user interface to its original size. On receiving a second zoom in gesture, zoom module 122 may zoom the content object beyond the bound.

Further still, the techniques may receive and respond to a pan gesture. Assume, for example, that a pan gesture is received through user interface 126 showing webpage 304 and zoomed content 602 both of FIG. 6. In response, zoom module 122 can pan within the bounds used to zoom the content object. This can aid in a good user experience, as otherwise a pan or other gesture could result in undesired objects being shown or desired content of the zoomed content object not being shown.

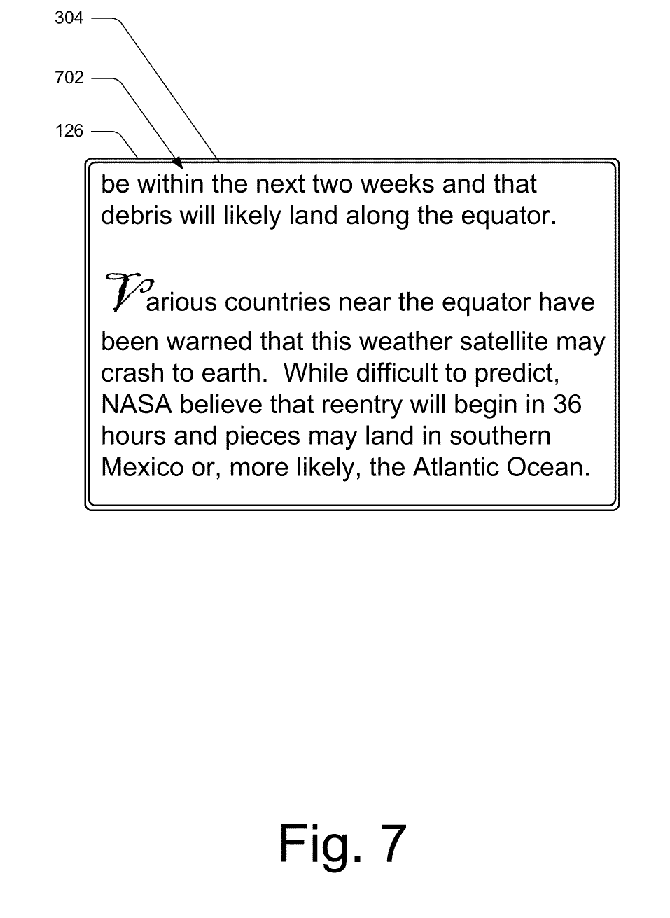

Thus, assume that a pan gesture is received panning down the news article shown as zoomed in FIG. 6. In response, zoom module 122 displays the content of the news article not yet shown, without altering the horizontal bounds or the resolution, and without showing other non-subordinate objects like the advertisements. Zoom module 122's response to receiving this pan is shown with panned, zoomed content 702 of FIG. 7 panned within the horizontal bounds and to vertical bound 508.

### Example Device

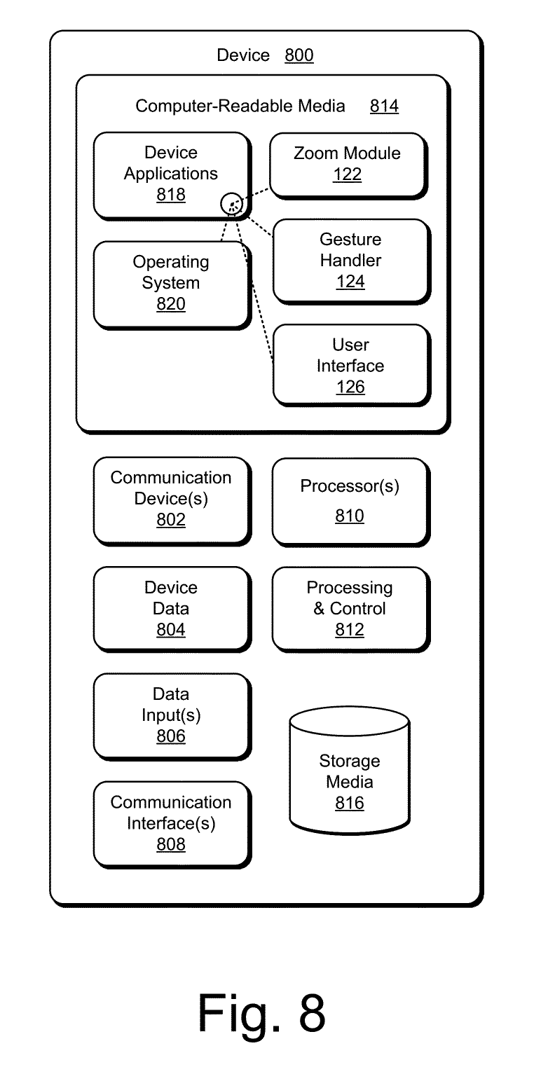

FIG. 8 illustrates various components of example device 800 that can be implemented as any type of client, server, and/or computing device as described with reference to the previous FIGS. 1-7 to implement techniques for gesture-based content-object zooming. In embodiments, device 800 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or System-on-Chip (SoC). Device 800 may also be associated with a user (e.g., a person) and/or an entity that operates the device such that a device describes logical devices that include users, software, firmware, and/or a combination of devices.

Device 800 includes communication devices 802 that enable wired and/or wireless communication of device data 804 (e.g., received data, data that is being received, data scheduled for broadcast, data packets of the data, etc.). The device data 804 or other device content can include configuration settings of the device, media content stored on the device, and/or information associated with a user of the device. Media content stored on device 800 can include any type of audio, video, and/or image data. Device 800 includes one or more data inputs 806 via which any type of data, media content, and/or inputs can be received, such as user-selectable inputs, messages, music, television media content, recorded video content, and any other type of audio, video, and/or image data received from any content and/or data source.

Device 800 also includes communication interfaces 808, which can be implemented as any one or more of a serial and/or parallel interface, a wireless interface, any type of network interface, a modem, and as any other type of communication interface. The communication interfaces 808 provide a connection and/or communication links between device 800 and a communication network by which other electronic, computing, and communication devices communicate data with device 800.

Device 800 includes one or more processors 810 (e.g., any of microprocessors, controllers, and the like), which process various computer-executable instructions to control the operation of device 800 and to enable techniques enabling and/or using gesture-based content-object zooming. Alternatively or in addition, device 800 can be implemented with any one or combination of hardware, firmware, or fixed logic circuitry that is implemented in connection with processing and control circuits which are generally identified at 812. Although not shown, device 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 800 also includes computer-readable storage media 814, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 800 can also include a mass storage media device 816.

Computer-readable storage media 814 provides data storage mechanisms to store the device data 804, as well as various device applications 818 and any other types of information and/or data related to operational aspects of device 800. For example, an operating system 820 can be maintained as a computer application with the computer-readable storage media 814 and executed on processors 810. The device applications 818 may include a device manager, such as any form of a control application, software application, signal-processing and control module, code that is native to a particular device, a hardware abstraction layer for a particular device, and so on.

Device applications 818 also include system components or modules to implement techniques using or enabling gesture-based content-object zooming. In this example, device applications 818 include zoom module 122, gesture handler 124, and user interface 126.

### CONCLUSION

Although embodiments of techniques and apparatuses enabling gesture-based content-object zooming have been described in language specific to features and/or methods, it is to be understood that the subject of the appended claims is not necessarily limited to the specific features or methods described. Rather, the specific features and methods are disclosed as example implementations for gesture-based content-object zooming.

What is claimed is:

1. A computer-implemented method comprising:
determining, based on a multi-finger zoom-in gesture having momentum, made over a user interface, and received through a gesture-sensitive display, a content object of multiple content objects in the user interface; and
zooming the content object to bounds of the content object effective to substantially fill the user interface with the content object.

2. A computer-implemented method as described in claim 1, wherein zooming the content object completely fills the user interface with the content object and ceases to present others of the multiple content objects.

3. A computer-implemented method as described in claim 1, wherein zooming the content object displays a progressive zooming animation from an original size of the content object to a final size of the content object.

4. A computer-implemented method as described in claim 1, wherein zooming the content object displays a snapping animation.

5. A computer-implemented method as described in claim 1, further comprising, responsive to a pan gesture made over the user interface and received through the gesture-sensitive display, panning the content object within the bounds.

6. A computer-implemented method as described in claim 5, wherein panning within the content object does not display others of the multiple content objects previously presented prior to zooming the content object.

7. A computer-implemented method as described in claim 5, wherein the bounds represent two horizontal bounds of the content object and panning the content object within the bounds pans vertically through the content object and within the two horizontal bounds.

8. A computer-implemented method as described in claim 1, wherein zooming the content object presents the content object at a new, final size without displaying a progressive zooming animation.

9. A computer-implemented method as described in claim 1, further comprising zooming out the content object within the user interface to an original size responsive to receipt of a multi-finger zoom-out gesture having momentum.

10. A computer-implemented method as described in claim 1, further comprising zooming the content object beyond the bounds responsive to receipt of a second multi-finger zoom-in gesture.

11. A system comprising:
one or more processors; and
one or more computer-readable storage devices having instructions stored thereon that are executable by the one or more processors to perform operations including:
determining, based on a multi-finger zoom-in gesture having momentum, made over a user interface, and received through a gesture-sensitive display, a content object of multiple content objects in the user interface; and
zooming the content object to bounds of the content object effective to substantially fill the user interface with the content object.

12. A system as described in claim 11, wherein zooming the content object completely fills the user interface with the content object and ceases to present others of the multiple content objects.

13. A system as described in claim 11, wherein zooming the content object displays a progressive zooming animation from an original size of the content object to a final size of the content object.

14. A system as described in claim 11, wherein zooming the content object displays a snapping animation.

15. A system as described in claim 11, further comprising, responsive to a pan gesture made over the user interface and received through the gesture-sensitive display, panning the content object within the bounds.

16. A system as described in claim 15, wherein panning within the content object does not display others of the multiple content objects previously presented prior to zooming the content object.

17. A system as described in claim 15, wherein the bounds represent two horizontal bounds of the content object and panning the content object within the bounds pans vertically through the content object and within the two horizontal bounds.

18. A computer-implemented method as described in claim 1, wherein zooming the content object presents the content object at a new, final size without displaying a progressive zooming animation.

19. A computer-implemented method as described in claim 1, further comprising zooming out the content object within the user interface to an original size responsive to receipt of a multi-finger zoom-out gesture having momentum.

20. One or more computer-readable storage memories storing instructions thereon that, upon execution by one or more processors of a computing device, cause the computing device to perform operations comprising:
determining, based on a multi-finger zoom-in gesture having momentum, made over a user interface, and received through a gesture-sensitive display, a content object of multiple content objects in the user interface; and
zooming the content object to bounds of the content object effective to substantially fill the user interface with the content object.
